(19) United States
(12) Patent Application Publication
(10) Pub. No.: US 2022/0063463 A1
(43) Pub. Date: Mar. 3, 2022

(54) VEHICLE SEAT

(71) Applicant: HONDA MOTOR CO., LTD., Tokyo (JP)

(72) Inventor: Rikiya OYAMA, Saitama (JP)

(21) Appl. No.: 17/391,046

(22) Filed: Aug. 2, 2021

(30) Foreign Application Priority Data
Aug. 26, 2020 (JP) 2020-142850

(51) Int. Cl. B60N 2/75; B60N 2/02

(52) U.S. Cl. CPC B60N 2/76; B60N 2/77; B60N 2/16; B60N 2/0244; B60N 2/0228

(57) ABSTRACT

A vehicle seat includes a seat part; a back part; a drive unit configured to adjust at least; one of a position of the seat part or a position of the back part; and operation switches via which the drive unit is driven, the operation switches being arranged adjacent to the seat part and face upward with respect to the seat part. The operation switches may be arranged on a side of the seat part, the side being adjacent to a door of a vehicle. The drive unit may disable an input from the operation switches if a door detection switch for detecting opening of the door detects that the door is open.

This Application is based on and claims the benefit of priority from Japanese Patent Application No. 2020-142850, filed on 26 Aug. 2020, the content of which is incorporated herein by reference.

### BACKGROUND OF THS INVENTION

### Field of the Invention

The present disclosure relates to a vehicle seat.

### Related Art

A known vehicle seat has, on a side surface thereof, switches for operating a seat position adjuster that adjusts a position of a seat part and a position of back part independently from each other (see, for example, Patent Document 1).

Patent Document 1: Japanese Unexamined Patent Application, Publication No. 2016-37107

### SUMMARY OF THE INVENTION

Since the switches for operating the seat position adjuster of the vehicle seat of Patent Document 1 are arranged at a location that cannot be seen from a seated person, the seated person needs to grope for the switches to operate them. Therefore, it is likely for an erroneous operation to occur.

The present disclosure is intended to provide a vehicle seat that allows a seated person to perform an operation for adjusting a seat position while directly visually discerning operation switches.

A first aspect of the present disclosure is directed to a vehicle seat (e.g., a vehicle seat 1 to be described later) including a seat part (e.g., a seat part 2 to be described later); a back part (e.g., a back part 3 to be described later); a drive unit (e.g., a drive unit 6 to be described later) configured to adjust at least one of a position of the seat part or a position of the back part; and an operation switch (e.g., operation switches 5 to be described later) via which the drive unit is driven. The operation switch is arranged adjacent to the seat part and faces upward with respect to the seat part.

A second aspect of the present disclosure is an embodiment of the vehicle seat according to the first aspect. In the second aspect, the operation switch may be arranged on a side of the seat part, the side being adjacent to a door (e.g., a door 101 to be described later) of a vehicle (e.g., a vehicle 100 to be described later) in which the vehicle seat is to be installed. The drive unit may disable an input from the operation switch if a door detection switch (e.g., a door detection switch 62 to be described later) for detecting opening of the door detects that the door is open.

A third aspect of the present disclosure is an embodiment of the vehicle seat according to the first or second aspect. In the third aspect, the seat part may include a seat cushion (e.g., a seat cushion 21 to be described later). The vehicle seat may further include an armrest (e.g., armrests 4 to be described later) that is retractable to be positioned along a side of the seat cushion and is deployable upwardly. The operation switch may be arranged on an upper surface (e.g., an upper surface 41a to be described later) of the armrest.

A fourth aspect of the present disclosure is an embodiment of the vehicle seat according to the third aspect. In the fourth aspect, the armrest may include an armrest body (e.g., an armrest body 41 to be described later) and a position adjustment mechanism (e.g., a position adjustment mechanism 42 to be described later) that is capable of adjusting the armrest body between at least two positions including a deployment position and a retraction position. An upper surface of the armrest body in the retraction position may be coplanar with an upper surface (e.g., an upper surface 21a to be described later) of the seat cushion.

A fifth aspect of the present disclosure is an embodiment of the vehicle seat according to the fourth aspect. In the fifth aspect, the position adjustment mechanism may enable multi-stage angle adjustment of the armrest body in the deployment position.

A sixth aspect or the present disclosure is an embodiment of the vehicle seat according to the fourth or fifth aspect. In the sixth aspect, the seat part may include a seat part body (e.g., a seat part body 22 to be described later) sized to have protruding portions (e.g., protruding portions 221 to be described later) that respectively protrude laterally outward relative to right and loft sides of the seat cushion, the seat part body being harder than the seat cushion. The armrest body in the retraction position stay be arranged on an upper surface (e.g., an upper surface 221a to be described later) of the protruding portion of the seat part body that protrudes relative to the seat cushion.

A seventh aspect of the present disclosure is an embodiment of the vehicle seat according to the sixth aspect. In the seventh aspect, the protruding portion may have a rib (e.g., a rib 222 to be described later) or a recess formed on the upper surface thereof. The armrest body may have a recess (e.g., a recess 415 to be described later) or a rib formed on a lower surface (e.g., a lower surface 414a to be described later) thereof, the recess or the rib of the armrest body being engageable with the rib or the recess of the protruding portion when the armrest body is in the retraction position.

According to the first aspect of the present disclosure, the seat switch for adjusting the position of the vehicle seat is arranged adjacent to the seat part and faces upward with respect to the seat part. This feature allows a seated person to easily operate the operation switches while directly visually discerning the operation switch.

The second aspect can reliably prevent an erroneous operation of the operation switch, which can occur when the operation switch contacts with a leg of a person who is getting in or out of the vehicle.

According to the third aspect, the operation switch is arranged on the upper surface of the armrest that is retracted to be positioned along a side of the seat cushion. This feature can keep the operation switch out of the way of the seated person. Further, when the armrest is retracted, a driver and a passenger(s) can easily move in a front-rear direction (walk through) in the vehicle, without being hindered by the armrest.

According to the fourth aspect, the upper surface of the armrest body in the retraction position is coplanar with the upper surface of the seat part. With this feature, the armrest in the retraction position is kept out of the way of the driver or the passenger who is getting in or out of the vehicle. Thus, the driver and the passenger can smoothly get in and out of the vehicle.

According to the fifth aspect, the position adjustment mechanism enables multi-stage angle adjustment, of the armrest body in the deployment position. This feature allows a seated person to deploy and optimally position the armrest according to his/her physique and liking.

According to the sixth aspect, the armrest body in the retraction position is arranged on the upper surface of the protruding portion of the seat part body that is harder than the seat cushion. This feature contributes to an increase in a load-carrying capacity of the armrest body in the retraction position.

According to the seventh aspect, the recess or the rib of the armrest body in the retraction position engages with the rib or recess of the protruding portion of the seat part body. This feature allows the armrest body in the retraction position to increase in load-carrying capacity in a lateral direction.

### BRIEF DESCRIPTION OF THE DRAWINGS

FIG. 1 is a front view of a vehicle seat;

FIG. 2 is a perspective view illustrating, on an enlarged scale, operation switches positioned adjacent to an upper surface of a seat part of the vehicle seat;

FIG. 3 is a side view illustrating the vehicle seat with armrests being deployed;

FIG. 4 is a perspective view illustrating the seat part of the vehicle seat with the armrests being deployed;

FIG. 5 is a perspective view illustrating an armrest body as viewed from below;

FIG. 6 is a diagram illustrating a structure via which the armrest body is mounted;

FIG. 7 is a cross-sectional view illustrating the armrest in a retraction position and the seat part, the cross-sectional view being taken along line A-A in FIG. 4;

FIG. 8 is a diagram illustrating a movement of a person who is getting in or out of a vehicle having the vehicle seat installed therein;

FIG. 9 is a functional block diagram of the vehicle seat;

FIG. 10 is a flowchart illustrating an operation for adjusting a position of the vehicle seat;

FIG. 11 is a diagram illustrating an angle adjustment mechanism of the armrest;

FIG. 12 is a diagram illustrating the angle adjustment mechanism of the armrest;

FIG. 13 is a diagram illustrating the angle adjustment mechanism of the armrest; and

FIG. 14 is a diagram illustrating the angle adjustment mechanism of the armrest.

### DETAILED DESCRIPTION OF THE INVENTION

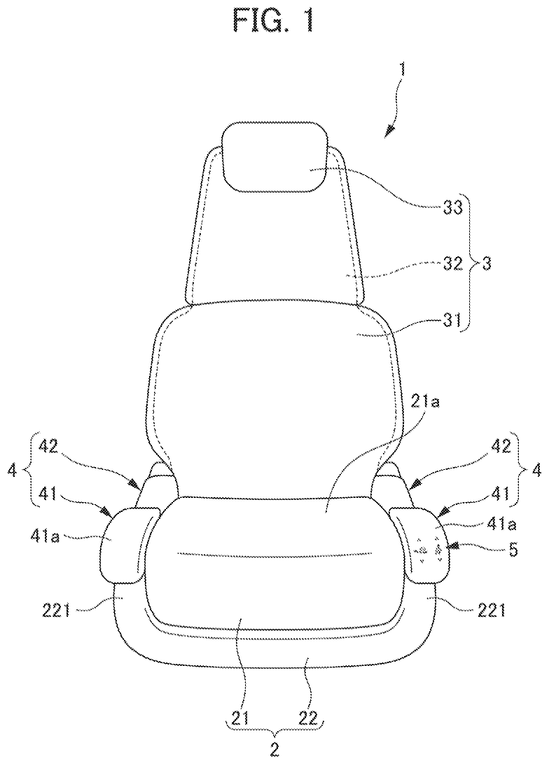

Embodiments of the present disclosure will be described in detail with reference to the drawings. As illustrated in FIGS. 1 to 4, a vehicle seat 1 according to the present embodiment is for one person, and includes a seat part 2 for supporting the buttocks of a seated person, a back part 3 for supporting the back of the seated person, and armrests 4. The back part 3 is pivotally mounted to be pivotable with respect to the seat part 2.

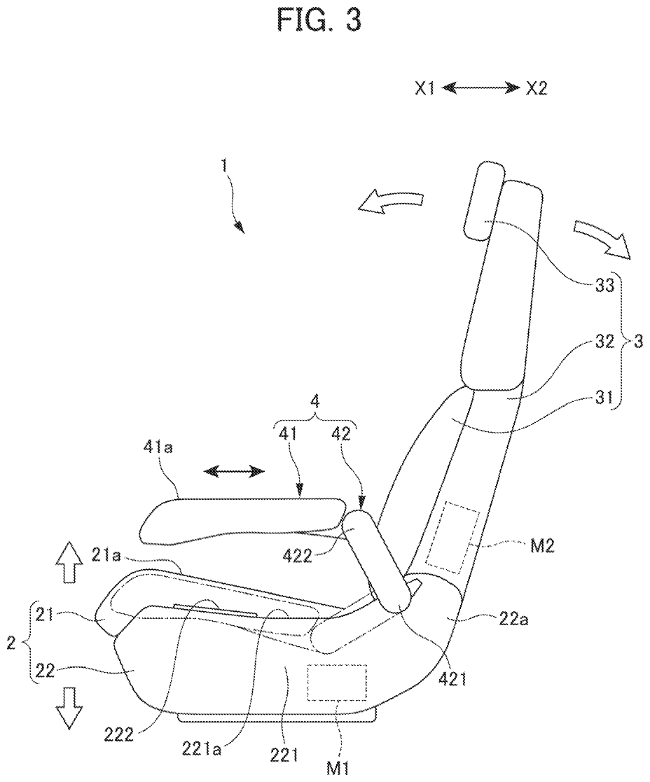

As indicated by the hollow arrows in FIG. 3, the vehicle seat 1 of the present embodiment is configured such that a position of the seat part 2 and a position of the back part; 3 are automatically adjustable. Specifically, the seat part 2 includes therein a height adjustment motor M1 for automatically adjusting a height of the seat part 2. The back part 3 includes therein an angle adjustment motor M2 for automatically adjusting an angle of the back part 3 in an X1 direction and an X2 direction. The X1 direction is a forward direction with respect to the vehicle seat 1. The X2 direction is a rearward direction with respect to the vehicle seat 1.

The seat part 2 includes a seat cushion 21 and a seat part body 22 that supports the seat cushion 21 from below. The seat cushion 21 has suitable cushioning that provides a comfortable ride for the seated person. On the other hand, the seat part body 22 is harder than the seat cushion 21 to stably support the seat cushion 21.

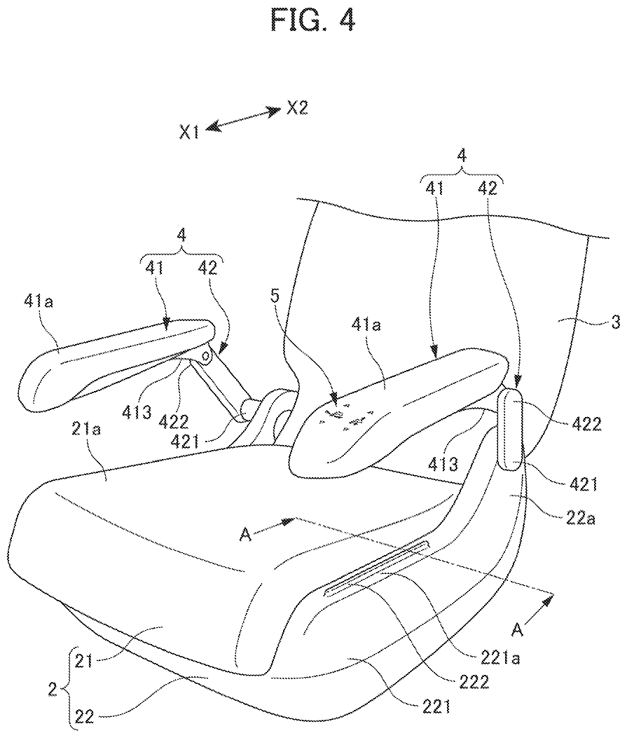

As illustrated in FIGS. 1 and 4, the seat part body 22 has such a size that the seat part body 22 has portions laterally protruding relative to the seat cushion 21. Thus, the seat part body 22 has protruding portions 221, 221 that respectively constitute right and left side portions of the seat part body 22 and protrude laterally outward relative to the seat cushion 21. As illustrated in FIGS. 3 and 4, the protruding portion 221 has an upper surface 221a and the seat cushion 21 has an upper surface 21a, the upper surface 221a being located below the upper surface 21a. The upper surface 221a of the protruding portion 221 is provided with a rib 222 that extends linearly in a front-rear direction. Although not illustrated, the protruding portion 221 located on the left side of the seated person has the same structure and is provided with a rib on the upper surface.

The back part 3 includes a back cushion 31, a back part body 32 that supports the back cushion 31 from rear, and a headrest 33 that is attached to an upper portion of the back part body 32. The back cushion 31 and the headrest 33 have suitable cushioning that provides a comfortable ride for the seated person. On the other hard, the back part body 32 is harder than the back cushion 31 and the headrest 33 to stably support the back cushion 31 end the headrest 33.

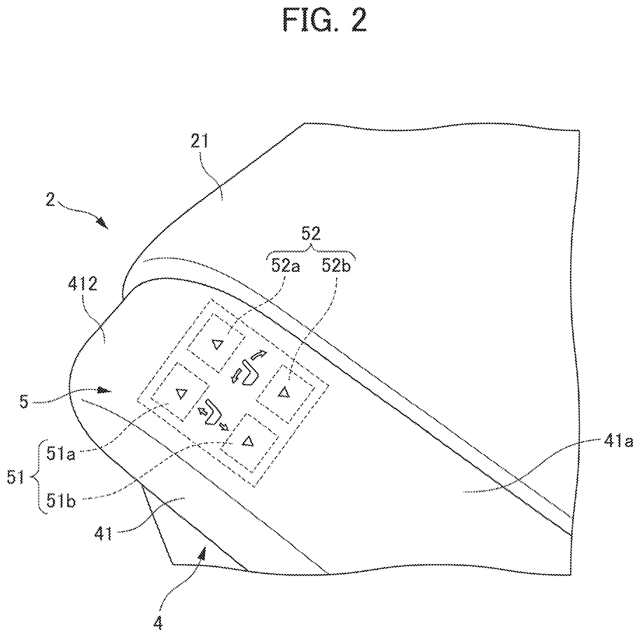

As illustrated in FIGS. 3 and 4, the armrest 4 includes an armrest body 41 that supports an arm of the seated person, and a position adjustment mechanism 42 via which the armrest body 41 is mounted to the seat part 2 and with which a position of the armrest body 41 is adjusted with respect to the seat part 2. The armrests 4 illustrated in FIGS. 1 and 2 are retracted end positioned along the lateral sides of the seat cushion 21. As illustrated in FIGS. 3 and 4, the armrest body 41 of each armrest 4 can be moved upward to be deployed above the seat part 2 by the seated person, so that the armrest 4 supports the arm of the seated person. The vehicle seat 1 of the present embodiment has a pair of armrests 4, 4 respectively arranged on the right and left sides of the seat cushion 21 such that both arms of the seated person can be supported. A specific structure for adjusting the position of the armrest 4 will be described later.

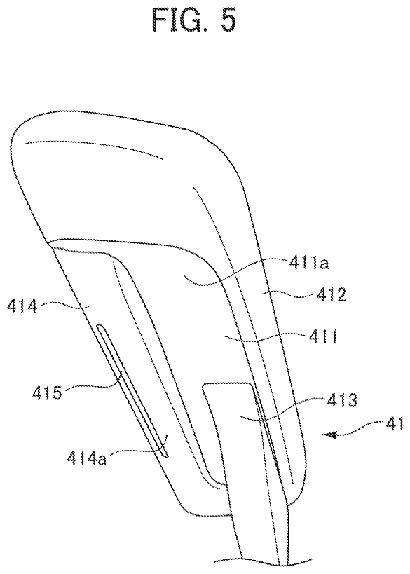

The armrest body 41 is a member that is long in the front-rear direction. As illustrated in FIG. 5, the armrest body 41 includes a core 411 that is coupled to the position adjustment mechanism 42, an exterior sheath 412 that covers a surface of the core 411 and imports suitable cushioning to the armrest body 41, and a coupler 413 that, couples the core 411 to the position adjustment mechanism 42 such that the core 411 is turnable with respect to the position adjustment mechanism 42. The exterior sheath 412 does not cover a lower surface 411a of the core 411. The core 411 of the armrest body 41 is slidable in the front-rear direction with respect to the coupler 413, as illustrated in FIG. 3. This configuration allows the seated person to adjust the position of the armrest body 41 in the front-rear direction as he/she desired.

FIG. 5 illustrates the armrest body 41 arranged on the left side of the seated person. The coupler 413 of the armrest body 41 is off-center with respect to the lower surface 411a of the core 411 and is close to a side of the core 411 located away from the seat part 2. The lower surface 411a of the core 411 is provided with a ridge 414 that protrudes downward and is integrated with the lower surface 411a. The ridge 414 is located closer than the coupler 413 to the seat part 2. The ridge 414 extends in the front-rear, direction of the armrest body 41. The ridge 414 has a lower surface 414a on which a recess 415 linearly extending in the front-rear direction is formed. The recess 415 corresponds to the rib 222 provided on the upper surface 221a of the protruding portion 221 of the seat part body 22, and is sized to be engageable with the rib 222. Although not illustrated, the other armrest 4, which is arranged on the right side of the seated person, has the same but reversed structure, and form a symmetrical pair with the armrest illustrated in FIG. 5.

As illustrated in FIG. 3, the position adjustment mechanism 42 includes a long member coupling the armrest body 41 to the seat part 2. The position adjustment mechanism 42 has a first pivot part 421 at one end thereof and a second pivot part 422 at the other end thereof. The position adjustment mechanism 42 is pivotally supported on each of right and left side surfaces of a rear end portion 22a of the seat part body 22 by means of the first pivot part 421 such that the position adjustment mechanism 42 is turnable. The position adjustment mechanism 42 pivotally supports the coupler 413 of the armrest body 41 by means of the second pivot part 422 such that the coupler 413 is turnable.

The position adjustment mechanism 42 is capable of adjusting the armrest body 41 between at least two positions: a deployment position In which the armrest body 41 is deployed above the seat part 2 (the position illustrated in FIGS. 3 and 4); and a retraction position in which the armrest body 41 is retracted to be positioned adjacent to the seat part 2 (the position illustrated in FIG. 1).

Specifically, when the position adjustment mechanism 42 is turned rearward around the first pivot part 421, the armrest body 41 is moved to the deployment position above the upper surface 21a of the seat cushion 21, as illustrated in FIGS. 3 and 4. This movement of the armrest bodes 41 to the deployment position brings the armrests 4 into a deployment state in which the armrests 4 can support the arms of the seated person. When the position adjustment mechanism 42 is turned forward around the first pivot part 421, the armrest body 41 is moved to the retraction position to come to lie along the upper surface 221a of the protruding portion 221 of the seat part body 22, as illustrated in FIG. 1. This movement of the armrest bodies 41 to the retraction position brings the armrests 4 into a retraction state.

As illustrated in FIGS. 1 and 2, in the retraction position, the armrest bodies 41 do not protrude upward or forward relative to the seat part 2. Therefore, the armrests 4 are kept out of the way of a driver or a passenger when he/she gets in or out of the vehicle. Thus, the vehicle seat 1 allows the driver and the passenger to easily get in and out of the vehicle even though it has the armrests 4. When the armrests 4 are in the retraction state, the driver and the passenger can easily move in the front-rear direction (walk through) in the vehicle, without being hindered by the armrests 4.

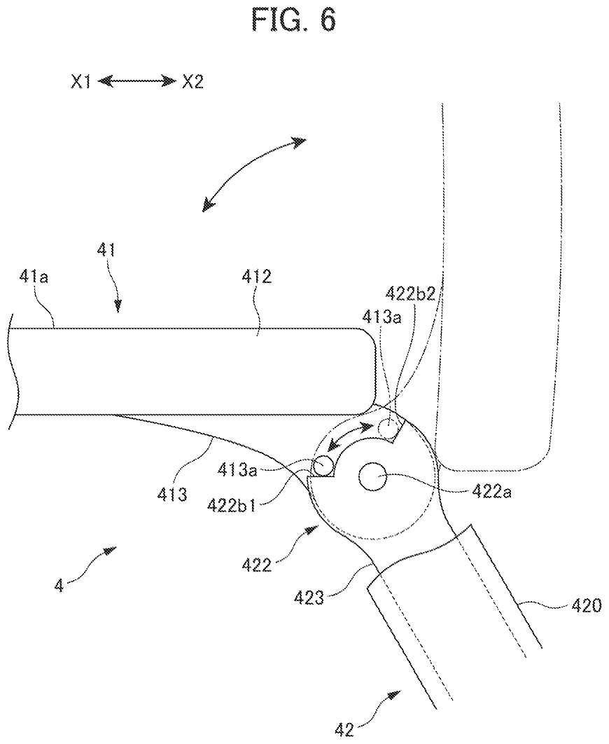

As illustrated in FIG. 6, the coupler 413 of the armrest body 41 is turnably mounted on a shaft 422a provided to the second pivot part 422 of the position adjustment mechanism 42. The shaft 422a of the second pivot part 422 is located on an end portion of a metal stay 423. The metal stay 423 is a long member that connects the first pivot part 421 and the second pivot part 422 of the position adjustment mechanism 42 to each other. The position adjustment mechanism 42 is formed by covering the metal stay 423 with a design cover 420 that is made of, for example, a resin.

The second pivot part 422 has an arc-shaped cutout 422b centered on the shaft 422a. The cutout 422b receives therein a projection 413a projecting from the coupler 413. The armrest body 41 can freely turn around the shaft 422a within a range corresponding to the cutout 422b in which the projection 413a can move.

In FIG. 6, the projection 413a at the position indicated by the solid curve is in contact with a front end 422b1 located on a front side of the cutout 422b. In this state, the armrest body 41 has been turned around the shaft 422a in the forward direction to a maximum extent. When the position adjustment mechanism 42 is turned rearward to move the armrest body 41 to the deployment position, the projection 413a comes into contact with the front end 422b1 of the cutout 422b, and thereby defines a limit of a forward turn range of the armrest body 41.

On the other hand, in FIG. 6, the projection 413a at the position indicated by the dot-dot-dash curve is in contact with a rear end 422b2 located on a rear side of the cutout 422b. In this state, the armrest body 41 has been turned around the shaft 422a in the rearward direction to a maximum extent. When the position adjustment mechanism 42 is turned forward to move the armrest body 41 to the retraction position, the projection 413a comes into contact with the rear end 412b2 of the cutout 422b, and thereby defines a limit of a rearward turn range of the armrest body 41. The position adjustment mechanism 42 will be described in more detail later.

As illustrated in FIG. 1, the armrest body 41 in the retraction position is on the upper surface 221a of the protruding portion 221 of the seat part body 22. The protruding portion 221 of the seat part body 22, which is harder than the seat cushion 21, can strongly support the armrest body 41 from below when a load is downwardly applied to the armrest body 41. With this configuration, the armrest body 41 in the retraction positron increases in load-carrying capacity.

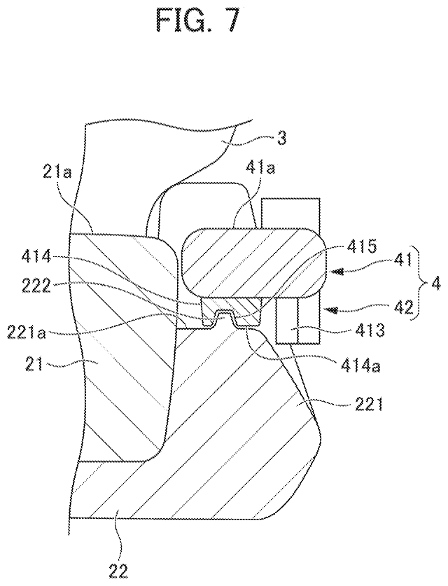

As illustrated in FIG. 7, when the armrest body 41 is in the retraction position, the rib 222 on the upper surface 221a of the protruding portion 221 engages with the recess 415 provided on the lower surface 414a of the ridge 414 of the armrest body 41. This configuration causes the armrest body 41 in the retraction position to be reliably positioned with respect to the upper surface 221a of the protruding portion 221, and hinders the armrest body 41 from moving in the lateral direction. Thus, the armrest body 41 in the retraction position increases in load-carrying capacity in the lateral direction. Note that the protruding portion 221 may have a recess and the armrest body 11 may have a rib.

As illustrated in FIGS. 1 and 2, each armrest 4 of the vehicle seat 1 of the present embodiment seems to form part of the seat part 2 when the armrests 4 are retracted and positioned along the lateral sides of the seat cushion 21. Therefore, when viewed from above, the seat part 2 of the vehicle sent 1 looks as if it is divided into the seat cushion 21 and the armrests 4. In this state, the upper surfaces of the armrests 4 are coplanar with the upper surface 21a of the seat cushion 21.

Note that a state described as upper surfaces 41a of the armrest bodies 41 are coplanar with the upper surface 21a of the seat cushion 21 is not limited to a configuration in which the position of the upper surfaces 41a and that of the upper surface 21a are precisely coincident with each other in the horizontal direction, but includes a configuration in which the upper surfaces 41a, 21a are substantially coplanar with each other. In other words, when the armrest bodies 41 are in the retraction position, it is only necessary for the upper surfaces 41a, 21a to be positioned to allow the seated person to move in the lateral direction without difficulty while remaining in a sitting posture, and a slight difference in the vertical direction between the upper surfaces 41a, 21a is permissible.

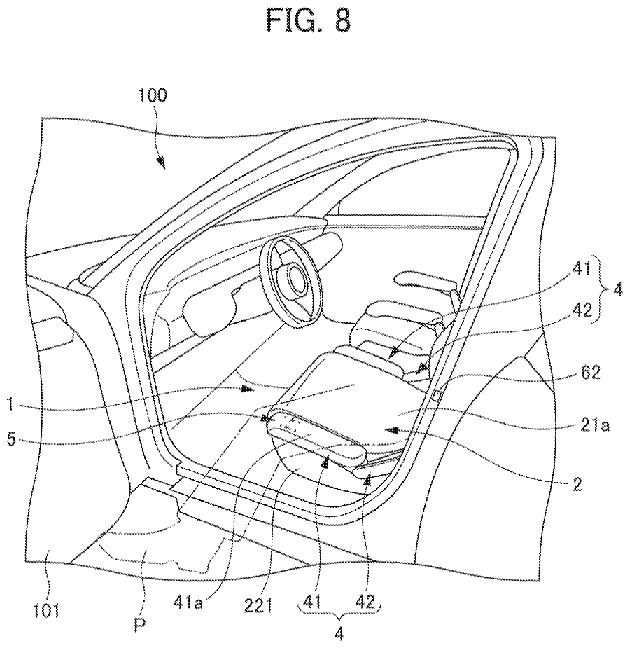

As illustrated in FIGS. 1, 2, and 4, operation switches 5 for automatically adjusting the seat position are arranged on the upper surface 41a of the armrest body 41. The operation switches 5 of the present, embodiment include height adjustment switches 51 for driving the height adjustment motor M1 installed in the seat part 2, and angle adjustment switches 52 for driving the angle adjustment motor M2 installed in the back part 3. As illustrated in FIG. 8, in the case of the vehicle seat 1 of the present embodiment, the armrest 4 with the operation switches 5 is arranged adjacent to a door 101 of a vehicle 100. That is, the operation switches 5 are arranged on a side of the seat part 2 adjacent to the door 101.

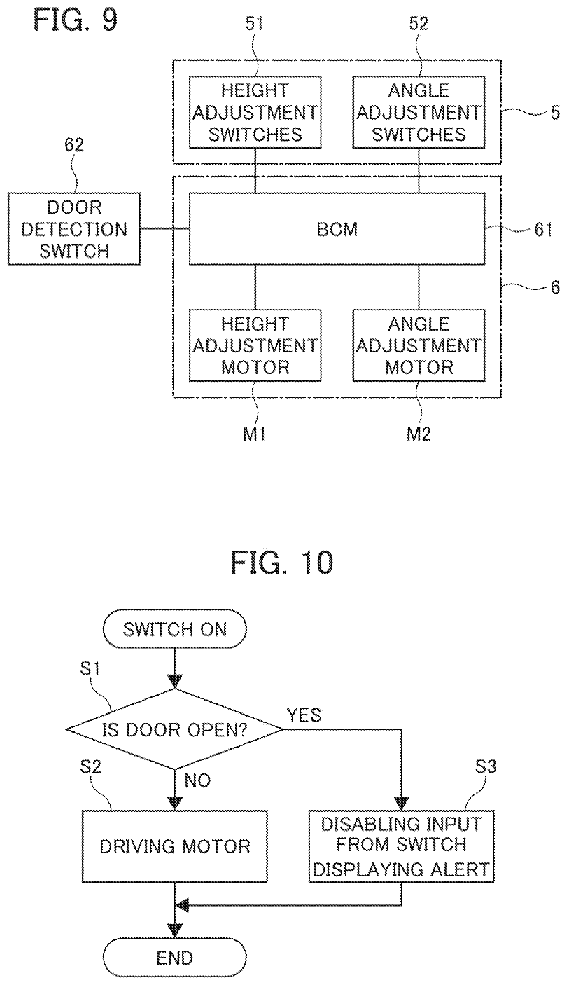

As illustrated in FIG. 9, the operation switches 5 are electrically connected to a drive unit 6, and allows the seated person to adjust, via the drive unit 6, the position of the seat part 2 and the position of the back part 3 independently from each other. The drive unit 6 includes a body control module (BCM) 61, the height adjustment motor M1, and the angle adjustment motor M2. The body control module 61 of the present embodiment functions as a controller for controlling position adjustment of the seat part 2 and the back part 3 of the vehicle seat 1. In response to an input from the height adjustment switches 51 and an input from the angle adjustment switches 52, the body control module 61 drives the height adjustment motor M1 and the angle adjustment motor M2 independently from each other to rotate the respective motors in a normal direction or a reverse direction. The body control module 61 may be installed in, for example, the seat part 2 or the back part 3. Alternatively, the body control module 61 may be installed at any other location in the vehicle 100.

As illustrated in FIG. 2, the height adjustment switches 51 include an upward movement switch 51a for driving the height adjustment motor M1 to move the seat part 2 upward, and a downward movement switch 51b for driving the height adjustment motor M1 to move the seat part 2 downward. The angle adjustment switches 52 include a forward inclination switch 52a for driving the angle adjustment motor M2 to incline the back part 3 forward, and a rearward inclination switch 52b for driving the angle adjustment motor M2 to incline the back part 3 rearward.

The operation switches 5 are all arranged on the upper surface 41a of the armrest body 41. The operation switches 5 of the present embodiment have a switch body embedded to be covered with the exterior sheath 412 of the armrest body 41. The switch body is operated when a corresponding portion of the upper surface 42a is pressed through the exterior sheath 412. The exterior sheath 412 has, on a surface thereof, marks indicating the functions and the like of the respective switches 51a, 51b, 52a, and 52b, the marks being formed by, for example, printing.

As can be seen, the vehicle seat 1 of the present embodiment includes, on the upper surface 41a of the armrest body 41, the operation switches 5 for adjusting the positions (height and angle) of the seat part 2 and the back part 3 by way or driving the drive unit 6. Accordingly, the operation switches 5 are arranged adjacent to the seat part 2 and face upward with respect to the seat part 2. This configuration allows the seated person to easily operate the operation switches 5 while directly visually discerning each of the operation switches when he/she adjusts the positions of the seat part 2 and the back part 3. Thus, the configuration reliably reduces the likelihood of erroneous operation, in comparison with the conventional case in which a seated person needy to grope for the switches to operate them.

As illustrated in FIGS. 8 and 9, the vehicle 100 is provided with a door detection switch 62 configured to detect opening of the door 101. The door detection switch 62 outputs a detection signal to the body control module 61 of the drive unit 6. The drive unit 6 is configured to control and drive the height adjustment motor M1 and the angle adjustment motor M2 based on the detection signal from the door detection switch 62 and the input through the operation switches 5.

The operation of the drive unit 6 is specifically described with reference to the flowchart of FIG. 10. When the seated person operates any one of switches 51a, 51b, 52a, and 52b of the operation switches 5, a Switch-ON signal is transmitted. Upon receiving the Switch-ON signal, the body control module 61 of the drive unit 6 checks whether the detection signal from the door detection switch 62 is present (Step S1). If the door 101 is not open, (NO in Step S1), the body control module 61 drives the height adjustment motor M1 or the angle adjustment motor M2, whichever corresponds to the seated person's operation via the switch (Step S2). On the other hand, if the detection signal indicating that the door 101 is open is received from the door detection switch 62 (YES in Step S1), the body control module 61 disables the input from the operation switches 5, and displays an alert on, for example, an instrument panel of the vehicle 100 (Step S3).

As can be soon, the drive unit 6 disables inputs via the operation switches 5 when the door detection switch 62 detects that the door 101 Is open. Therefore, even in the case in which the operation switches 5 are arranged adjacent to the door 101 of the vehicle 100 as illustrated in FIG. 8, and accordingly, are likely to contact with a leg of the person P getting in or out of the vehicle 100, the operation switches 5 are prevented from being operated unintentionally, thereby reliably enabling prevention of erroneous operation.

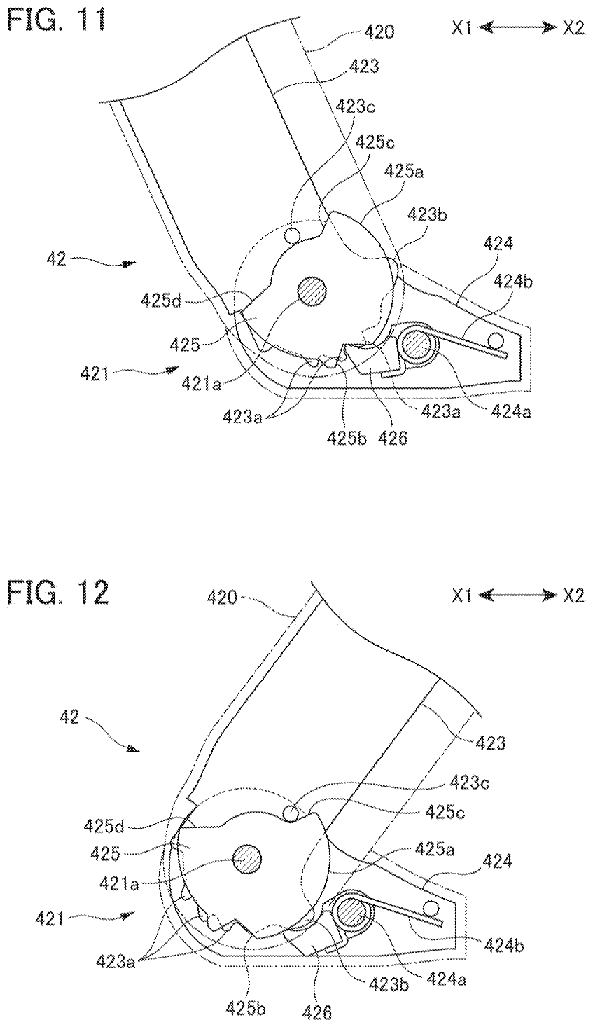

Next, the structure for adjusting the position of the armrest 4 is specifically described with reference to FIGS. 11 to 14. FIGS. 11 to 14 illustrate specifics of the structure of the first pivot part 421 of the position adjustment mechanism 42. The position adjustment mechanism 42 of the present embodiment is constituted by a ratchet mechanism that can perform multi-stage adjustment by turning and setting the armrest body 41 at multiple positions including the deployment position and the retraction position.

As illustrated in FIG. 11, the first pivot part 421 of the position adjustment mechanism 42 has the shaft 421a projecting from a metal anchor 424. The shaft 421a pivotally supports the metal stay 423 and a cam plate 425. The metal anchor 424 is mounted to a side of the rear end portion 22a of the seat part body 22.

The metal anchor 424 has another shaft 424a pivotally supporting a pawl 426 in a turnable manner. The metal stay 423 has an end which is arranged in the first pivot part 421, and an outer periphery of which is provided with a plurality of ratchet teeth 423a and one protruding stopper 423b. A spring 424b provided on the metal anchor 424 urges the pawl 426 in a direction in which the pawl 426 is meshed with the ratchet teeth 423a of the metal stay 423.

The cam plate 425 has, on an outer periphery thereof, a guide surface 425a, a notch 425b, a first contact portion 425c, and a second contact portion 425d. The guide surface 425a has an arc shape and is sized to have an outer edge located slightly radially outward relative to the ratchet teeth 423a so as to hinder the pawl 426 from meshing with the ratchet teeth 423a. The notch 425b has a substantially V-shape and allows the pawl 426 to mesh with the ratchet teeth 423a. The first contact portion 425c and the second contact portion 425d are configured to contact with a restriction projection 423c projecting from the metal stay 423.

FIG. 14 illustrates a state in which the metal stay 423 has been turned forward to a maximum extent with respect to the metal anchor 424 (and in which the armrest body 41 is in the retraction position). In this state, the pawl 426 is fitted in the notch 425b of the cam plate 425 while the second contact portion 425d of the cam plate 425 is in contact with the restriction projection 423c of the metal stay 423. On the other hand, FIG. 12 illustrates a state in which the metal stay 423 has been turned rearward to a maximum extent with respect to the metal anchor 424. In this state, the first contact portion 425c of the cam plate 425 is in contact with the restriction projection 423c of the metal stay 423.

The plurality of ratchet teeth 423a are configured such that when meshed with the pawl 126, the ratchet teeth 423a prevent the metal stay 423 from turning forward, but allows the metal stay 423 to turn rearward. As illustrated in FIG. 11, an angle by which the metal stay 423 is allowed to turn is set by way of meshing of the pawl 42c with one of the ratchet teeth 423a. With this configuration, the position adjustment mechanism 42 positions the armrest body 41 in the deployment position in which the armrest body 41 is deployed and positioned above the retraction position. When the metal stay 423 turns rearward, the pawl 426 becomes meshed with a different one of the ratchet teeth 423a. This configuration enables the position adjustment mechanism 42 to perform multi-stage position adjustment of the armrest body 41 in the deployment position. Thus, the seated person can deploy and optimally position the armrest bodies 41 according to his/her physique and liking.

As illustrated in FIG. 12, when the metal stay 423 has been turned rearward to the maximum extent, the stopper 423b provided to the metal stay 423 is in contact with an upper surface of the pawl 426 and turns the pawl 426 away from the ratchet teeth 423a, against the urging force of the spring 424b. In this state, the restriction projection 423c of the metal stay 423 is in contact with the first contact portion 425c of the cam plate 425. As a result, the cam plate 425 turns rearward in conjunction with the rearward turn of the metal stay 423, whereby the guide surface 425a of the cam plate 425 comes into contact with the pawl 426. Since the guide surface 425a has the outer edge located radially outward relative to the ratchet teeth 423a, the contact of the pawl 426 with the guide surface 425a causes the ratchet teeth 423a to become unmeshed with the pawl 426.

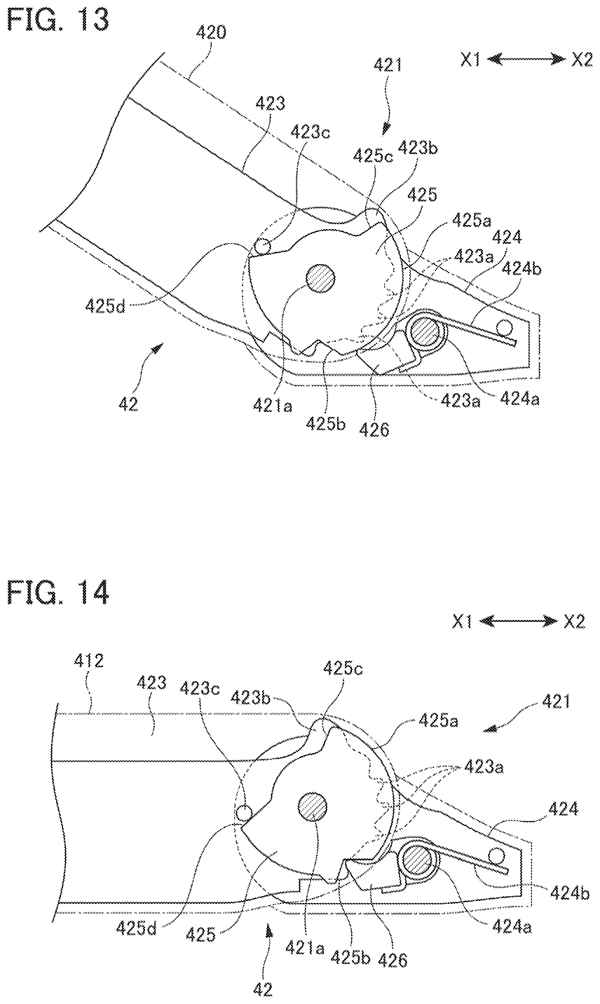

In the state where the pawl 426 is in contact with the guide surface 425a of the cam plate 425, when the seated person moves the armrest body 41 toward the retraction position, the metal stay 423 turns forward along with the movement of the armrest body 41, as illustrated in FIGS. 13 and 14. The turn of the metal stay 425 causes the restriction projection 423c to move from first contact portion 425c to the second contact portion 425d of the cam plate 425. While the metal stay 423 moves in this way, the cam plate 425 is not turned and the pawl 426 is maintained in contact with the guide surface 425a of the cam plate 425.

As illustrated in FIG. 14, in the state where the armrest body 41 is in the retraction position, the pawl 426 is fitted in the notch 425b because the restriction projection 425c of the metal stay 425 has turned the cam plate 425 forward while being in contact with second contact portion 425d of the cam plate 425. Thereafter, when the seated person moves the armrest body 41 upward toward the deployment position, the metal stay 423 turns rearward. As a result, one of the ratchet teeth 423a is meshed with the pawl 426 as illustrated in FIG. 11, whereby the armrest body 41 is positioned as desired in the deployment position.

The position adjustment mechanism 42 of the present embodiment has the ratchet mechanism implemented in the first pivot part 421. However, a similar ratchet mechanism may be implemented in the second pivot part 422. This configuration enables multi-stage adjustment of an angle between the armrest body 41 in the deployment position and the metal stay 423 of the position adjustment mechanism 42.

Note that the ratchet mechanism described above is a non-limiting example. In the vehicle seat 1, it is merely necessary for the position adjustment mechanism 42 of the armrest 4 to have a mechanism capable of adjusting the armrest body 41 between at least two positions including the deployment position and the retraction position.

The vehicle seat 1 of the present embodiment has two armrests 4 respectively provided on the right and left sides of the seat part 2. However, the armrest 4 may be provided only one of the right and left sides of the seat part 2. The vehicle seat 1 with the armrest(s) 4 is not limited to a driver's seat, but is applicable to all the seats in a vehicle. Further, the vehicle seat is not limited to a seat for one person, but is applicable to, for example, a seat for two or three persons, such as a vehicle rear seat.

The operation switches 5 may be immovably provided on a side of the seat cushion 21 so as to face upward with respect to the seat part 2. The operation switches 5 may include, in addition to the height adjustment switches 51 and the angle adjustment switches 52, other switches (not illustrated) for adjusting the seat position, such as front-rear adjustment switches for adjusting the position of the seat part 2 in the front-rear direction, and switches for adjusting the shape of the seat. The operation switches 5 may include only one type of switches among the foregoing types of switches. Further, the operation switches 5 may be arranged on a side of the seat part 2, the side adjacent to the center of the vehicle.

### EXPLANATION OF REFERENCE NUMERALS

1: Vehicle Seat
2: Seat Part
21: Seat Cushion
21a: Upper Surface of Seat Part
22: Seat Part Body
221: Protruding Portion
221a: Upper Surface of Protruding Portion
222: Rib
3: Back Part
4: Armrest
41: Armrest Body
41a: Upper Surface of Armrest Body
414a: Lower Surface of Armrest Body
415: Recess
42: Position Adjustment Mechanism
5: Operation Switches
6: Drive Unit
62: Door Detection Switch
100: Vehicle
101: Door

What is claimed is:

1. A vehicle seat comprising:
a seat part;
a back part;
a drive unit configured to adjust at least one of a position of the seat part or a position of the back part; and
an operation switch via which the drive unit is driven,
wherein the operation switch is arranged adjacent to the seat part and faces upward with respect to the seat part.

2. The vehicle seat according to claim 1,
wherein the operation switch is arranged on a side of the seat part, the side being adjacent to a door of a vehicle in which the vehicle seat is to be installed, and
wherein the drive unit disables an input from the operation switch if a door detection switch for detecting opening of the door detects that the door is open.

3. The vehicle seat according to claim 1,
wherein the seat part includes a seat cushion,
wherein the vehicle seat further comprises an armrest that is retractable to be positioned along a side of the seat cushion and is deployable upwardly, and
wherein the operation switch is arranged on an upper surface of the armrest.

4. The vehicle seat according to claim 3,
wherein the armrest includes an armrest body and a position adjustment mechanism that is capable of adjusting the armrest body between at least two positions including a deployment position and a retraction position, and
wherein an upper surface of the armrest body in the retraction position is coplanar with an upper surface of the seat cushion.

5. The vehicle seat according to claim 4,
wherein the position adjustment mechanism enables multi-stage angle adjustment of the armrest body in the deployment position.

6. The vehicle seat according to claim 4,
wherein the seat part includes a seat part body sized to have protruding portions that respectively protrude laterally outward relative to right and left sides of the seat cushion, the seat part body being harder than the seat cushion, and
wherein the armrest body in the retraction position is arranged on an upper surface of the protruding portion of the seat part body that protrudes relative to the seat cushion.

7. The vehicle seat according to claim 6,
wherein the protruding portion has a rib or a recess formed on the upper surface thereof, and
wherein the armrest body has a recess or a rib formed on a lower surface thereof, the recess or the rib of the armrest body being engageable with the rib or the recess of the protruding portion when the armrest body is in the retraction position.
